(19) United States
(12) Patent Application Publication
(10) Pub. No.: US 2006/0260886 A1
(43) Pub. Date: Nov. 23, 2006

(54) COAXIAL HELICAL BRAKE AND METHOD OF BRAKING IN LIGHTWEIGHT BRAKE CONFIGURATION

(76) Inventors: Lester J. Erlston, Beaverton, OR (US); Michael D. Miles, Portland, OR (US)

Correspondence Address: MARGER JOHNSON & MCCOLLOM, P.C., 210 SW MORRISON STREET, SUITE 400, PORTLAND, OR, 97204, US

(21) Appl. No.: 11/461,912

(22) Filed: Aug. 2, 2006

Related U.S. Application Data
(63) Continuation-in-part of application No. PCT/US05/03781, filed on Feb. 3, 2005.
(60) Provisional application No. 60/711,804, filed on Aug. 26, 2005.
(60) Provisional application No. 60/542,523, filed on Feb. 5, 2004.

(51) Int. Cl. F16D 55/36

(52) U.S. Cl. 188/71.5

(57) ABSTRACT

A coaxial helically actuated disc brake is provided. The coaxial disc brake includes a pressure plate that is rotationally actuated and helically guided by a brake support structure to axially engage a brake pad carrier with a rotor. The pressure plate, brake pad carrier and rotor are all coaxial with the rotating member upon which the coaxial disc brake acts. Multiple concentric pressure plates and brake pad carriers can be used. Multiple brake pad carriers acting as stators can be coaxially stacked between multiple coaxial rotors. A low friction device, material or element can be placed between the pressure plate and brake pad carrier to allow for easier disengagement of the brake.

### RELATED APPLICATION DATA

This application claims priority from U.S. provisional patent application 60/711,804, filed Aug. 26, 2005, and is a continuation-in-part of PCT application No. PCT/US2005/03781, filed Feb. 3, 2005, which claimed priority from U.S. provisional patent application Ser. No. 60/542,523, filed Feb. 5, 2004, all incorporated by reference herein.

### FIELD OF THE INVENTION

This invention relates to disc brakes and more particularly to coaxially helically acting disc brakes.

### BACKGROUND OF THE INVENTION

A screw action disc brake is described in U.S. Pat. No. 6,112,862 (“the '862 patent”). The disc brake described in the '862 patent provided advantages over a conventional caliper disc brake but has a significant drawback. The disc brake of the '862 patent tends to seize or “lock-up” when the brake is applied while the vehicle to which it is mounted is traveling in reverse.

The '862 patent disclosed at column 1, lines 62-65, that the “direction of the screw-threads must be such that when the collar is rotated on the cradle in the opposite direction to that of the forward turning hub it moves towards the brake disc.” The reason that the collar in the '862 patent, to which the brake pad is affixed, must rotate on its support element towards the disc in the opposite direction of the forward turning hub is that when the brake is applied, the brake pad works against the rotation of the disc and so cannot tighten against the disc. In fact, the brake pad will tend to be spun away from the disc when the brake is released.

However, when the vehicle is driven in reverse in the '862 patent, the collar, when the brake is applied, rotates towards the disc in the same directional rotation as the disc. Because of the helical motion of the collar and the friction generated between the brake pad and disc, the pad tends to tighten against the disc until the brake locks up and seizes. Furthermore, the '862 patent does not disclose a means to disengage the brake.

The brakes disclosed in U.S. Pat. Nos. 4,596,316 and 4,567,967, utilize ball screws to move a pressure plate axially toward a brake pad but specifically decouple and isolate the helical motion from the axial movement. In these brakes, the pressure plate does not rotate helically during the braking action. Such decoupling of the helical motion from the pressure plate would address the “lock-up in reverse” issue discussed above in the '862 patent, but would negate the advantages that the helical motion offers, namely, the propensity for the brake pad to be “spun” away from the rotor/disc when the brake is released, or, if the helical angle is reversed, create a self-energizing braking action.

Bicycle coaster brakes also utilize helical motion. The bicycle coaster brake typically operates by way of two shoes (or in some designs a conical shoe with a split along its axis) that sit along the radius of the axle inside the hub, or by way of a stack of alternating rotors and stators located within the hub. When the axle is reversed (when the rider backpedals), a helical piece on the axle, called a driver, is engaged moving a cone into the shoes that expands the shoes outward to contact the hub shell. Or, in the case of rotors and stators, the rotors and stators are forced to contact each other. In most coaster brakes, the braking power is supplied by metal-to-metal contact. Numerous U.S. patents for coaster brakes disclose such helical actuation.

Another aspect of braking technology is the combination disc and parking brake. The reasons for having a separate parking brake integral with a disc brake are explained in “A short Course on Brakes,” by Charles Ofria found at <http://www.familycar.com/brakes.htm>. The following excerpt explains some of the reasons:
The parking brake (a.k.a. emergency brake) system controls the rear brakes through a series of steel cables that are connected to either a hand lever or a foot pedal. The idea is that the system is fully mechanical and completely bypasses the hydraulic system so that the vehicle can be brought to a stop even if there is a total brake failure. On drum brakes, the cable pulls on a lever mounted in the rear brake and is directly connected to the brake shoes. This has the effect of bypassing the wheel cylinder and controlling the brakes directly.
Dis[e] brakes on the rear wheels add additional complication for parking brake systems. There are two main designs for adding a mechanical parking brake to rear dis[c] brakes. The first type uses the existing rear wheel caliper and adds a lever attached to a mechanical corkscrew device inside the caliper piston. When the parking brake cable pulls on the lever, this corkscrew device pushes the piston against the pads, thereby bypassing the hydraulic system, to stop the vehicle. This type of system is primarily used with single piston floating calipers; if the caliper is of the four (or multiple) piston fixed type then that type of system can't be used. The other system uses a complete mechanical drum brake unit mounted inside the rear rotor.

The brake shoes on this system are connected to a lever that is pulled by the parking brake cable to activate the brakes. The brake “drum” is actually the inside part of the rear brake rotor.

Such parking drum brakes mounted within disc brake rotors are disclosed in U.S. Pat. Nos. 6,484,852; 5,715,916; 5,529,149; 5,180,037; 4,995,481; 4,854,423; 4,313,528; 3,850,266; and 3,447,646. With respect to concentric “brakes within brakes,” see U.S. Pat. No. 4,809,824 to Fargier et al., Method and Device for Actuating a Braking Mechanism By a Rotating Electric Motor.

Accordingly, a better form of disc brake is needed preferably incorporating a parking brake.

### SUMMARY OF THE INVENTION

One aspect of an embodiment of the present invention relates to a brake that solves the “braking in reverse” lock-up issue described above by dividing the abovementioned collar into two separate elements. One element is a pressure plate that rotates in a helical motion on a support element. Another element is a brake pad carrier that can be coupled to and disengaged from the pressure plate.

In this embodiment, the pressure plate, like the collar, rotates in a helical motion (which couples rotational motion to axial motion) on the support element. The function of the pressure plate is to push the brake pad, which can be fixedly mounted on the brake pad carrier, into contact with a rotor. The helical motion of the pressure plate generates increased braking torque due to its inherent wedge-like or camming properties. The helical motion may be achieved in a number of ways including but not limited to screw threads, bearing balls or rollers in races, pins or track rollers in grooves, or by a combination of radially-arranged linear actuators.

This embodiment creates the helical motion of the pressure plate in relation to the support element by a series of equidistantly spaced helical grooves with semi-circular profiles formed into the pressure plate's inner radial surface which, in effect, forms the outer ring of a helical ball bearing arrangement. Matching grooves are similarly formed into the outer radial surface of the support element which, in effect, forms the inner ring of a helical ball bearing arrangement. When the pressure plate is mounted on the support element, the aligned grooves on the pressure plate and support element form circularly shaped helical races. A series of ball bearings, suitably caged, can be inserted into each race.

In another embodiment, the inner and outer rings having aligned helical grooves are separate elements from the pressure plate and support element and can be combined to form a complete helical ball bearing unit that is inserted between the support element and the pressure plate.

The major components of the embodiments comprise a support element, a pressure plate, a brake pad carrier, a brake pad, and a rotor, all of which are coaxial with each other, and a means of actuating the brake.

Within the various embodiments, the brake pad, which can be formed as a continuous annular ring of friction material or can comprise individual segments of friction material attached to or integral with a backing plate, is fixedly mounted on the brake pad carrier. The brake pad carrier is mounted on either the pressure plate or the support element in such a fashion that the brake pad carrier is coaxial with the pressure plate. The helical advance of the pressure plate maintains the face of the brake pad parallel to the rotor surface. This allows for equal loading or distribution of force between the brake pad and the rotor surface.

Also, the face of the pressure plate is fitted with features, such as, but not limited to, lugs or teeth, which engage features on the back of the brake pad carrier and couple the pressure plate and brake pad carrier together so that they rotate as one when the brake is actuated. The engagement features are designed to allow a small amount of rotational movement or slack sufficient to enable the pressure plate to rotate away from the brake pad carrier in order to unseize or disengage the brake. A return spring between the pressure plate and the support element, together with a friction minimizing element or features placed between the pressure-plate and the brake pad carrier, can be incorporated to assist and encourage such disengagement.

When the brake is applied, the actuator, which includes but is not limited to mechanical, hydraulic, pneumatic, spring, electric or magnetic systems, causes the pressure plate to rotate on the support element and move towards the brake pad carrier, pushing the brake pad into contact with the rotor. The actuator can include a multiplicity of actuators and the actuator(s) can be mounted on the support element, the vehicle, or some other fixed point. The actuator is mounted in such a manner so as to provide the most useful rotational actuation to the pressure plate. The most favorable location and direction of the actuator would be acting tangentially at the largest radius practical from the axle/brake assembly centerline. A return spring and wear adjustment mechanism may be incorporated into the means of actuation or mounted directly to the relevant components, the vehicle, or some other fixed point.

More advantages of the invention are that minimal clearance is needed between the pressure plate, brake pad carrier/brake pad, and the rotor, and that only a few degrees of rotation of the pressure plate on the support element is required to engage the brake. The amount of rotational movement is governed by the helix angle and lead of the thread or thread equivalent; for example a 5:1 lead ratio means that 5 mm of rotation (at the radius of the thread) results in 1 mm of axial movement. Given minimum friction, a mechanical advantage of 5:1, due to the leverage effect, would be generated.

In another embodiment of the invention, concentric arrangement of the brake elements enables multiple concentric pressure plates and brake pad carriers to be incorporated into the design of a particular brake depending upon the desired function and performance characteristics. Each pressure plate in a concentric arrangement can have a specific helical angle to determine its rate of axial motion and direction of rotation. Each pressure plate can have its own actuator or multiple actuators, or a single or multiple actuators can actuate all pressure plates simultaneously. Multiple actuators can be used to provide increased actuation force and/or redundancy. The outermost concentric pressure plate will generate the most braking torque, with each inner concentric pressure plate generating less torque. An inner pressure plate is suited to parking brake or emergency brake use.

The coaxial helical brake may be actuated by applying a tangential force to the pressure plate via a rotary actuator which creates a torque sufficient to rotate the pressure plate in relation to the support element. Such rotational actuation may be achieved by electric, hydraulic, pneumatic or mechanical means. Electric rotary actuators comprise electric motors such as, but not limited to, conventional electric motors, pancake motors, ring motors and stepper motors. Hydraulic and pneumatic rotary actuators comprise hydraulic or pneumatic motors respectively.

The rotary actuator may be mounted eccentrically or concentrically to the axis of the brake, and may be perpendicular or skewed to the axis of the brake. The rotary actuator may include gears, linkages, shafts and other mechanical means to effect the power conversion to drive the pressure plate. The rotary drive may be geared directly to the pressure plate by means of a corresponding gear on the pressure plate, by means of a cam which engages a corresponding feature on the pressure plate, or by means of a gear train including, but not limited to, spur gears or spur gear segments, helical gears, bevel gears, spiral bevel gears, worm gears, harmonic drives, sprockets operating in conjunction with chains or toothed belts, and other means of power transmission.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a perspective exploded view of an embodiment of a coaxial helical brake according to the invention.

FIG. 2 is a cross-sectional view of the coaxial helical brake of FIG. 1.

FIG. 3 is a perspective exploded view of another embodiment of a coaxial helical brake according to the invention.

FIG. 4 is a cross-sectional view of the coaxial helical brake of FIG. 3.

FIG. 5 is a perspective exploded view of yet another embodiment of a coaxial helical brake according to the invention.

FIG. 6 is a cross-sectional view of the coaxial helical brake of FIG. 5.

FIG. 7 is a perspective exploded view of yet another embodiment of a coaxial helical brake according to the invention.

FIG. 8 is a cross-sectional view of the coaxial helical brake of FIG. 7.

FIG. 9 is a perspective view of the assembled coaxial helical brake of FIG. 1 showing a brake actuator.

FIG. 10 is a cross-sectional view of yet another embodiment of a coaxial helical brake according to the invention for use with axles using ball bearings for axle bearings.

FIG. 11 is a top plan view of a brake pad carrier according to an embodiment of the invention showing segmented brake pad material.

FIG. 12 is a top plan view of a segmented brake pad carrier according to another embodiment of the invention.

FIG. 13 is a perspective exploded view of a coaxial disc brake according to another embodiment of the invention showing the segmented brake pad carrier of FIG. 12.

FIG. 14 is a perspective view of an aircraft-type multiple rotor and stator brake application according an embodiment of the invention.

FIG. 15 is a detailed perspective cut-away view of the brake application of FIG. 14.

FIG. 16 is a detailed perspective view of the brake application of FIG. 14 showing the Pressure Plate in phantom line.

FIG. 17 is a half cross-sectional view of the brake application of FIG. 14 with the tire removed.

FIG. 18 is a perspective cut-away view of the brake application of FIG. 14 showing the Pressure Plate and the Stack of Rotors and Stators partially cut away.

FIG. 19 is a cross-sectional view of the brake application of FIG. 14 showing a rotary actuator.

FIG. 20 is a front cross-sectional elevation of the brake application of FIG. 19.

### DETAILED DESCRIPTION

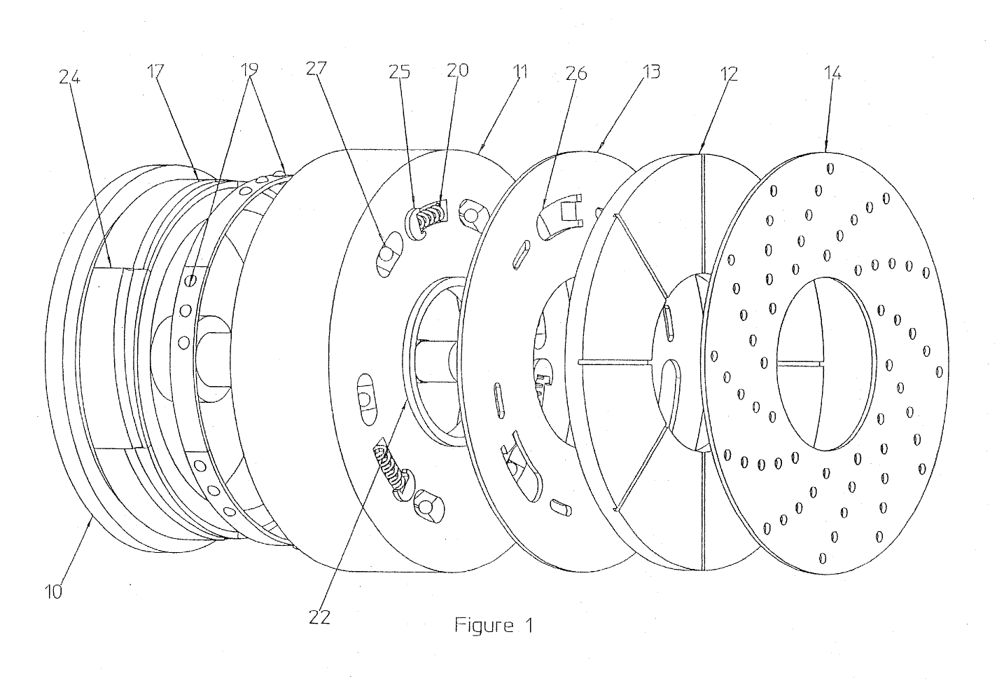

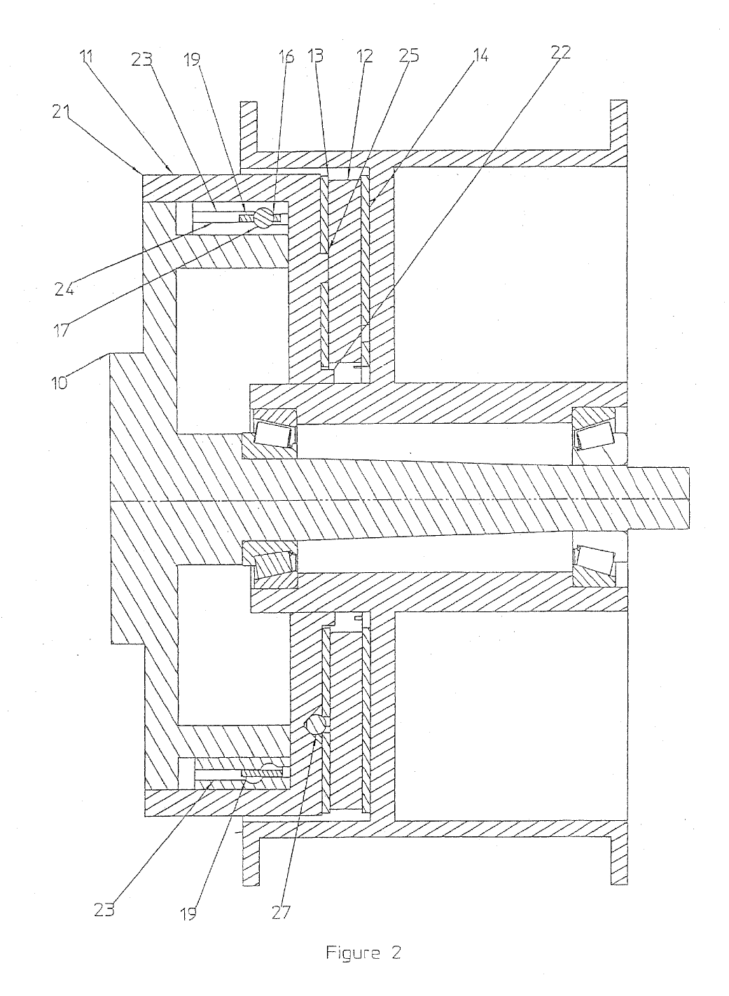

FIGS. 1 and 2 show an embodiment of a coaxial helical brake utilizing a single pressure plate 11 and a single brake pad carrier 13. With the brake helically rotating in a direction opposite of rotor rotation, this configuration is suitable for use on vehicles that do not require a parking brake like, for example, motorcycles and bicycles.

With the brake helically rotating in the same direction of rotor rotation this configuration is suitable for use as a safety brake or an emergency brake in such applications including elevators, cranes, lawnmowers and chain saws. When the helical rotation is in the same direction as rotor rotation, the brake will lock up or seize after a specific event or action triggers its actuation.

Referring to FIGS. 1 and 2, a support element 10 is fitted with brackets (not shown) to mount it to the vehicle or item to be braked (not shown). A pressure plate 11 has a boss 21 affixed to or integral with its rear surface. An annular brake pad 12 is affixed to the front surface of a brake pad carrier 13. The brake pad may also comprise individual segments of friction material. The pressure plate 11 is fitted with a circular flange 22, which locates and centers the brake pad carrier 13. A rotor 14 is affixed to the rotatable hub or wheel of the vehicle or item to be braked (not shown).

A series of equidistantly spaced helical grooves 16 with semicircular profiles is formed into the pressure plate boss's inner surface 23, and a matching series of grooves 17 is formed into the outer surface 24 of the support element 10. When the pressure plate 11 is mounted on the support element 10 the aligned grooves 16 and 17 form circular races 18. A caged series of bearing balls 19 is inserted into each race 18.

A series of lugs 25 is located on the face of the pressure plate 11 and a similar series of lugs 26 is located on the back surface of the brake pad carrier 13. The lugs 25 and 26 are designed to engage when the pressure plate 11 is rotated towards the brake pad carrier 13 so that the brake pad carrier 13 rotates with the pressure plate 11. A small amount of rotational movement allows the pressure plate 11 to disengage and rotate away from the pad carrier 13 when the brake is released. To assist such disengagement, a thrust race 27 or similar friction-minimizing technique is located on the face of the pressure plate 11, and a return spring 20 is affixed to both the pressure plate 11 and the support element 10.

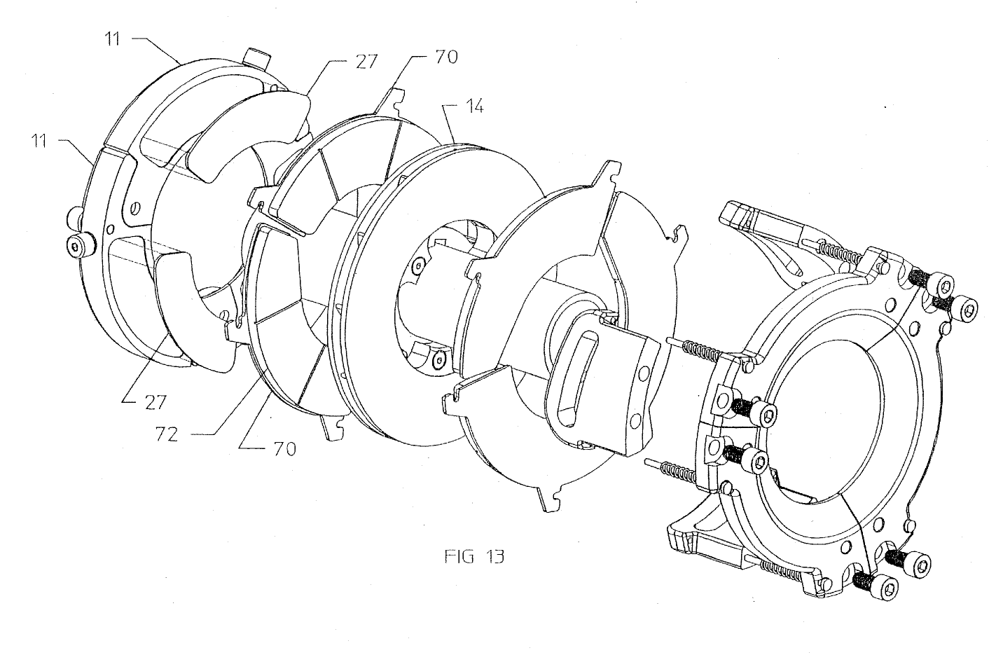

Other friction minimizing techniques include interposing a low-friction slip plate 27 (see FIG. 13) between the pressure plate 11 and the brake pad carrier 13. The slip plate 27 can be made of a graphite-based material or can be made of a material impregnated with graphite or some other low-friction material. Minimizing friction can also be achieved by applying a coating, finish or surface treatment to either or both the engagement surfaces of the pressure plate 11 and the brake pad carrier 13. An example of such a coating is Hi-T-Lube® manufactured by General Magnaplate Corporation.

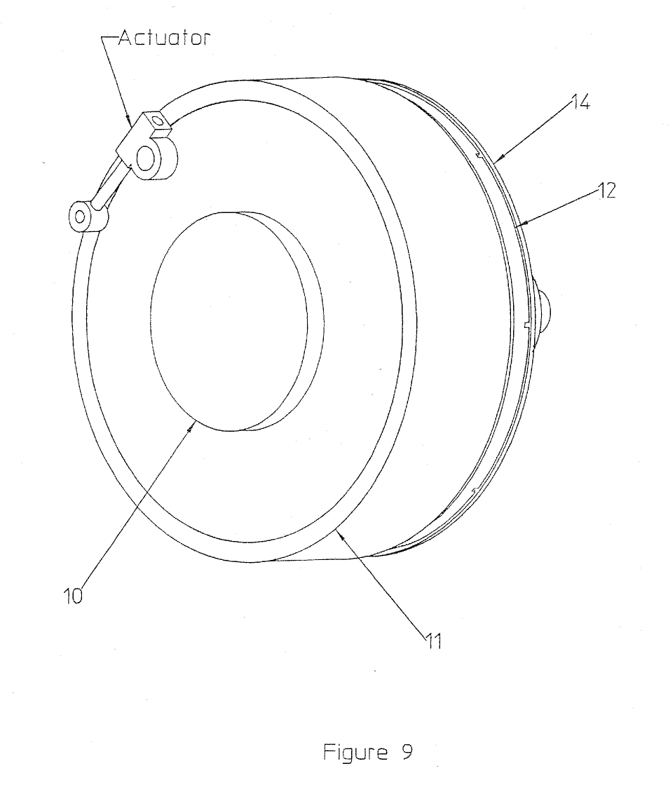

An actuation mechanism 15 (shown in FIG. 9) is mounted on the support element 10 in such a fashion so as to provide the most useful rotational actuation to the pressure plate 11. A brake adjuster assembly may be of any appropriate conventional. When the brake is applied the actuator 15, which includes but is not limited to mechanical, hydraulic, pneumatic, spring, electric or magnetic systems, causes the pressure plate 11 to rotate on the support element 10 and move towards the brake pad carrier 13, pushing the brake pad 12 into contact with the rotor 14. The actuator 15 can include a multiplicity of actuators and the actuator(s) can be mounted on the support element 10, the vehicle, or some other fixed point. The actuator 15 can be mounted in such a manner so as to provide the most useful rotational actuation to the pressure plate 11. The most favorable location and direction of the actuator 15 would be acting tangentially at the largest radius practical from the axle/brake assembly centerline, as shown in FIG. 9. A return spring and wear adjustment mechanism may be incorporated into the means of actuation or mounted directly to the relevant components, the vehicle, or some other fixed point.

A further embodiment of the invention is dependant upon the use of anti-lock braking (ABS) technology. As in the emergency brake described above, this embodiment has the helical rotation of the pressure plate 11 in the same direction as the rotor rotation. Due to the helical motion of the pressure plate 11 and the friction created between the brake pad 12 and the rotor 14, the brake pad 12 tends to tighten against the rotor 14, generating a self-energizing braking action that will ultimately lock up or seize the brake. Incorporating an electronic ABS system into this embodiment will prevent such lock-up and provide a powerful braking system. As shown below in other embodiments, a separate parking brake pressure plate, with or without a separate dedicated brake pad carrier, can be incorporated into this embodiment.

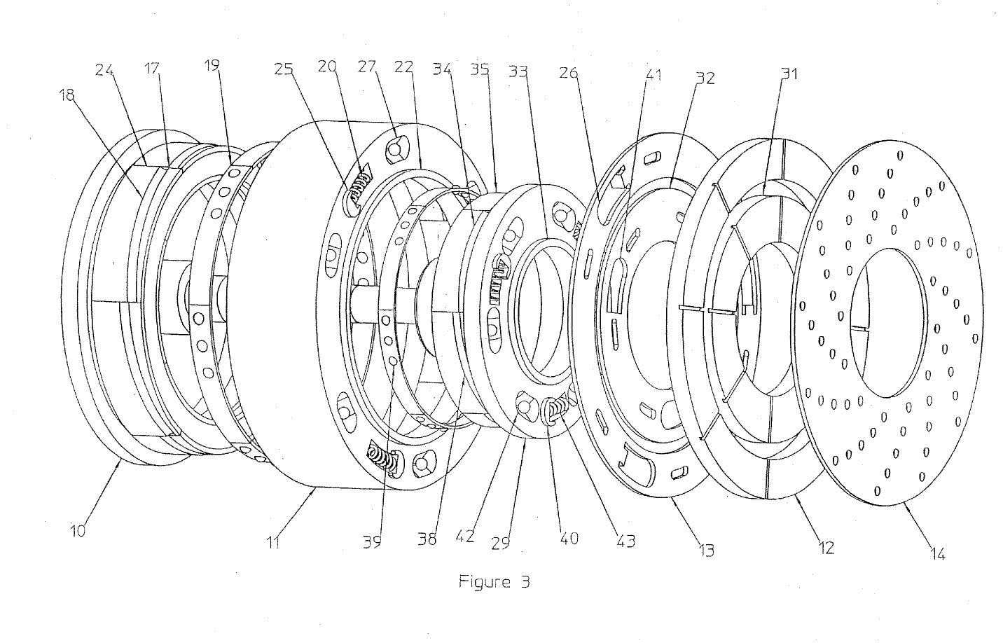

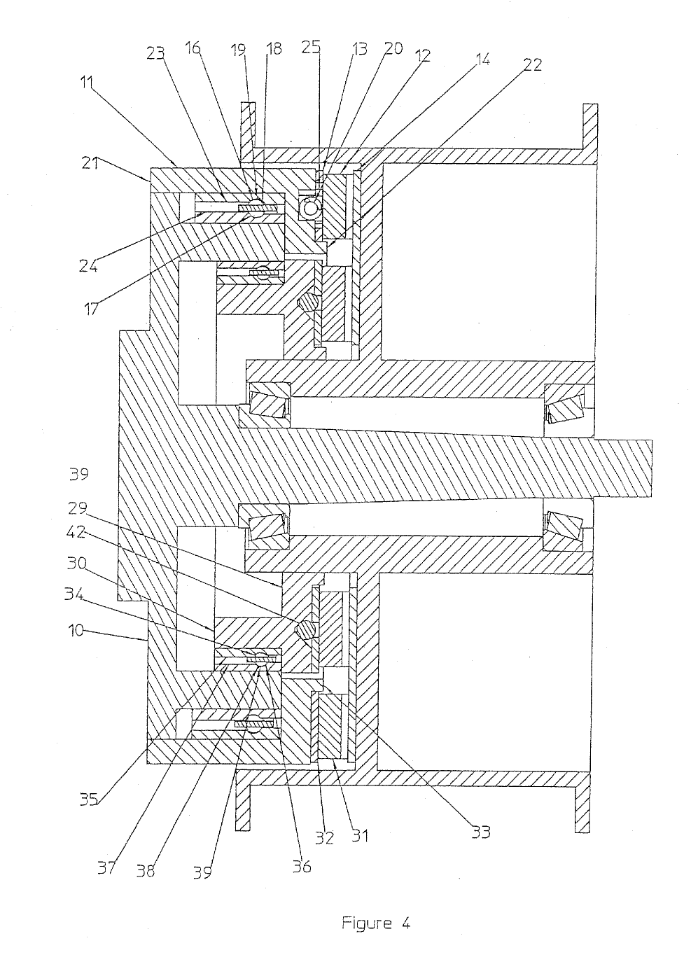

FIGS. 3 and 4 show another embodiment of a coaxial helical brake utilizing inner and outer concentrically arranged pressure plates. The outer pressure plate 11 has a helical rotation opposite of the rotor rotation and the inner pressure plate 29 has a helical rotation in the same direction as rotor rotation forming a safety or parking brake. The inner pressure plate 29, which can be mechanically actuated for safety reasons, can engage the same brake pad carrier 13 as the outer pressure plate 11 or engage a separate dedicated parking brake pad carrier 32. This configuration of concentrically arranged pressure plates is suited to most wheeled vehicles including motorcars, aircraft and railway vehicles, that require additional safety or parking brakes.

Referring to FIGS. 3 and 4, a support element 10 is fitted with brackets (not shown) to mount it to the vehicle (not shown). An outer pressure plate 11 has a boss 21 affixed to or integral with its rear surface. An annular outer brake pad 12 is affixed to the front surface of an outer brake pad carrier 13. The outer brake pad may also comprise individual segments of friction material. The outer pressure plate 11 is fitted with a circular flange 22, which locates and centers the outer brake pad carrier 13. A rotor 14 is affixed to the rotatable hub or wheel of the vehicle to be braked (not shown).

A series of equidistantly spaced helical grooves 16 with semicircular profiles is formed into the outer pressure plate boss's inner surface 23, and a matching series of grooves 17 is formed into the outer surface 24 of the support element 10. When the outer pressure plate 11 is mounted on the support element 10 the aligned grooves 16 and 17 form circular races 18. A caged series of bearing balls 19 is inserted into each race 18.

A series of lugs 25 is located on the face of the outer pressure plate 11 and a similar series of lugs 26 is located on the back surface of the outer brake pad carrier 13. The lugs 25 and 26 are designed to engage when the outer pressure plate 11 is rotated towards the outer brake pad carrier 13 so that the outer brake pad carrier 13 rotates with the outer pressure plate 11. A small amount of rotational movement allows the outer pressure plate 11 to disengage and rotate away from the outer pad carrier 13 when the brake is released. To assist such disengagement, a thrust race 27 or similar friction-minimizing device is located on the face of the outer pressure plate 11, and a return spring 20 is affixed to both the outer pressure plate 11 and the support element 10.

An actuation mechanism 15 (shown in FIG. 9) is mounted on the support element 10 in such a fashion so as to provide the most useful rotational actuation to the outer pressure plate 11. A brake adjuster assembly may be of any appropriate conventional type. When the brake is applied the actuator 15, which includes but is not limited to mechanical, hydraulic, pneumatic, spring, electric or magnetic systems, causes the outer pressure plate 11 to rotate on the support element 10 and move towards the outer brake pad carrier 13, pushing the outer brake pad 12 into contact with the rotor 14. The actuator 15 can include a multiplicity of actuators and the actuator(s) can be mounted on the support element 10, the vehicle, or some other fixed point. The actuator 15 can be mounted in such a manner so as to provide the most useful rotational actuation to the outer pressure plate 11. The most favorable location and direction of the actuator 15 would be acting tangentially at the largest radius practical from the axle/brake assembly centerline, as shown in FIG. 9. A return spring and wear adjustment mechanism may be incorporated into the means of actuation or mounted directly to the relevant components, the vehicle, or some other fixed point.

An inner pressure plate 29 has a boss 30 affixed to or integral with its rear surface. An annular inner brake pad 31 is affixed to the front surface of an inner brake pad carrier 32. The inner brake pad may also comprise individual segments of friction material. The inner pressure plate 29 is fitted with a circular flange 33, which locates and centers the inner brake pad carrier 32.

A series of equidistantly spaced helical grooves 34 with semicircular profiles is formed into the inner pressure plate boss's outer surface 35, and a matching series of grooves 36 is formed into the inner surface 37 of the support element 10. When the inner pressure plate 29 is mounted on the support element 10 the aligned grooves 34 and 36 form circular races 38. A caged series of bearing balls 39 is inserted into each race 38.

A series of lugs 40 is located on the face of the inner pressure plate 29 and a similar series of lugs 41 is located on the back surface of the inner brake pad carrier 32. The lugs 40 and 41 are designed to engage when the inner pressure plate 29 is rotated towards the inner brake pad carrier 32 so that the inner brake pad carrier 32 rotates with the inner pressure plate 29. A small amount of rotational movement allows the inner pressure plate 29 to disengage and rotate away from the inner pad carrier 32 when the brake is released. To assist such disengagement, a thrust race 42 or similar friction-minimizing device is located on the face of the inner pressure plate 29, and a return spring 43 is affixed to both the inner pressure plate 29 and the support element 10.

An inner brake actuation mechanism (not shown) is mounted on the support element in such a fashion so as to provide the most useful rotational actuation to the inner pressure plate. A brake adjuster assembly may be of any appropriate conventional type needing no detailed description for the purpose of this invention. When the inner brake is applied the inner brake actuator, which is preferably mechanical but also could be hydraulic, pneumatic, spring, electric or magnetic systems, causes the inner pressure plate 29 to rotate on the support element 10 and move towards the inner brake pad carrier 32, pushing the inner brake pad 31 into contact with the rotor 14 and in the same rotational direction as rotor 14. Because the helical rotation of the inner pressure plate is in the same direction as the rotor rotation, the inner brake pad 31 can cause the rotor 14 to seize or lock-up, thereby providing an effective parking or emergency brake. A return spring and wear adjustment mechanism may be incorporated into the means of inner actuation or mounted directly to the relevant components, the vehicle, or some other fixed point.

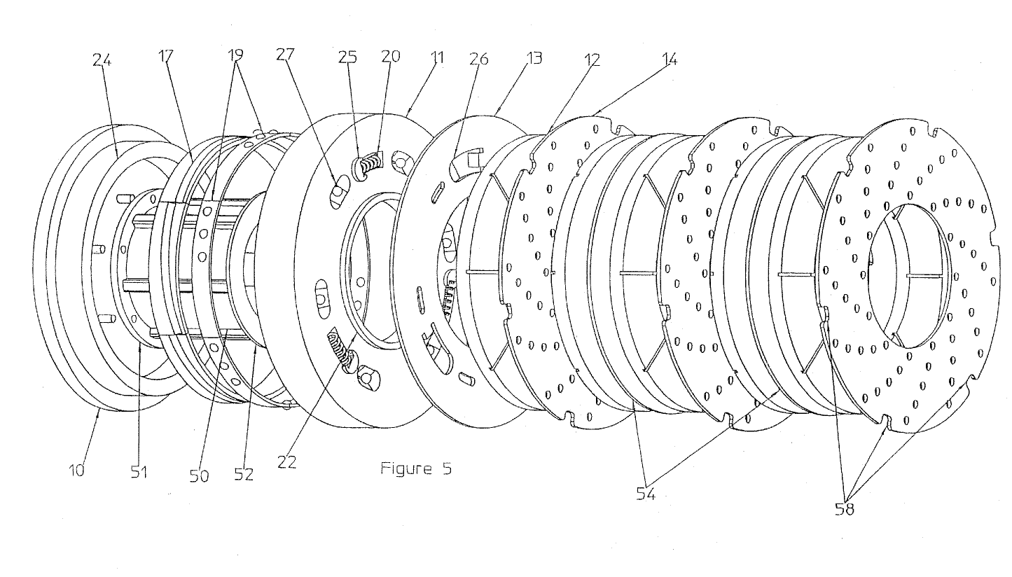

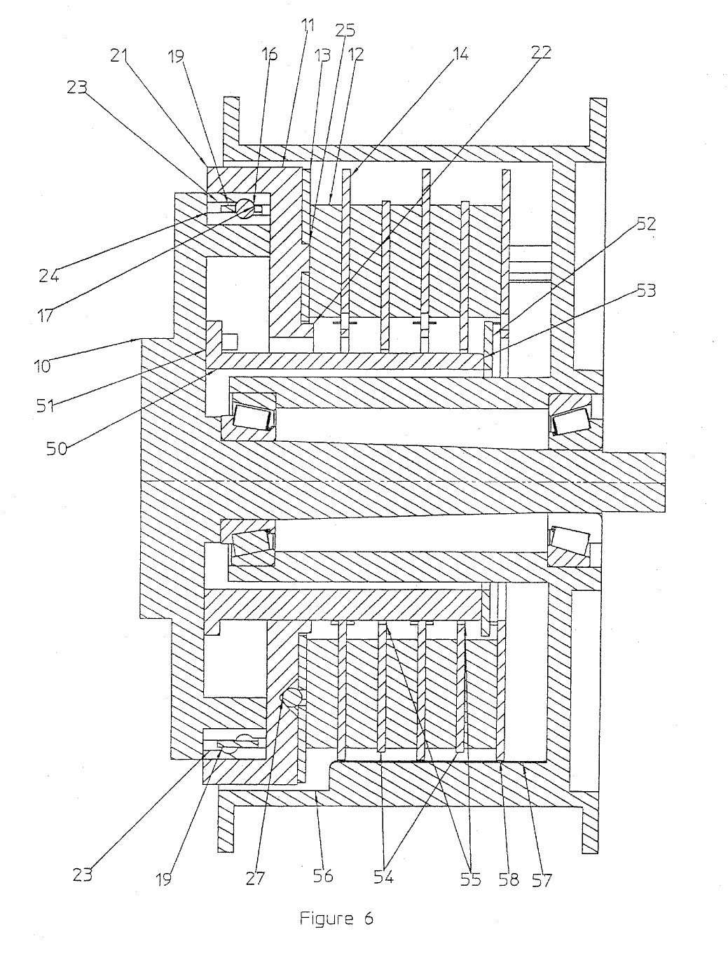

FIGS. 5 and 6 show yet another embodiment of a coaxial helical brake that utilizes multiple rotors and brake pads. This configuration is suited for use in large vehicles and high-speed aircraft. In order to increase braking torque in these heavy-duty applications, the embodiment includes a stack of alternating rotors 14 and stators 54 with the rotors being keyed to a rotate with the vehicle's wheels and with the stators 54 keyed to a splined torque tube 50 and not rotating with the vehicle's wheels. The torque tube 50 has a cylindrical shape and is typically made of steel and is affixed to or integral with the support element 10 but can be affixed to the vehicle itself or some other fixed point. The pressure plate 11 pushes the brake pad carrier 13 toward the stack of rotors 14 and stators 54 forcing them into contact with each other to create the braking action. As in the previous embodiment, a parking brake pressure plate, with or without a separate brake pad carrier can be incorporated into this embodiment.

Referring to FIGS. 5 and 6, a support element 10 is fitted with brackets (not shown) to mount it to the vehicle (not shown). A pressure plate 11 has a boss 21 affixed to or integral with its rear surface. An annular brake pad 12 is affixed to the front surface of a brake pad carrier 13. The pressure plate 11 is fitted with a circular flange 22, which locates and centers the brake pad carrier 13.

A splined torque tube 50 is affixed, at its forward end 51, to the support element 10. A back plate 52 is affixed to the back end of the torque tube 50. A series of annular brake pad stators 54, each stator having appropriately placed tangs 55, which engage with the splines of the torque tube 50, is mounted on the torque tube 50. The inner section of the aircraft's wheel that surrounds the brake 56 is fitted with splines 57. A series of rotors 14, each rotor having appropriately placed tangs 58 which engage with the aforementioned wheel splines 57, is mounted on the wheel in such a manner that the rotors 14 and stators 54 alternate.

A series of equidistantly spaced helical grooves 16 with semicircular profiles is formed into the pressure plate boss's inner surface 23, and a matching series of grooves 17 is formed into the outer surface 24 of the support element 10. When the pressure plate 11 is mounted on the support element 10 the aligned grooves 16 and 17 form circular races 18. A caged series of bearing balls 19 is inserted into each race 18.

A series of lugs 25 is located on the face of the pressure plate 11 and a similar series of lugs 26 is located on the back surface of the brake pad carrier 13. The lugs 25 and 26 are designed to engage when the pressure plate 11 is rotated towards the brake pad carrier 13 so that the brake pad carrier 13 rotates with the pressure plate 11. A small amount of rotational movement allows the pressure plate 11 to disengage and rotate away from the pad carrier 13 when the brake is released. To assist such disengagement, a thrust race 27 or similar friction-minimizing device is located on the face of the pressure plate 11, and a return spring 20 is affixed to both the pressure plate 11 and the support element 10.

An actuation mechanism 15 is mounted on the support element in such a fashion so as to provide the most useful rotational actuation to the pressure plate. A brake adjuster assembly may be of any appropriate conventional type. When the brake is applied the actuator 15, which includes but is not limited to mechanical, hydraulic, pneumatic, spring, electric or magnetic systems, causes the pressure plate 11 to rotate on the support element 10 and move toward the stack of rotors 14 and stators 54 forcing them into contact with each other to create the braking action. The actuator 15 can include a multiplicity of actuators and the actuator(s) can be mounted on the support element 10, the vehicle, or some other fixed point. The actuator 15 can be mounted in such a manner so as to provide the most useful rotational actuation to the pressure plate 11. The most favorable location and direction of the actuator 15 would be acting tangentially at the largest radius practical from the axle/brake assembly centerline, as shown in FIG. 9, A return spring and wear adjustment mechanism may be incorporated into the means of actuation or mounted directly to the relevant components, the vehicle, or some other fixed point.

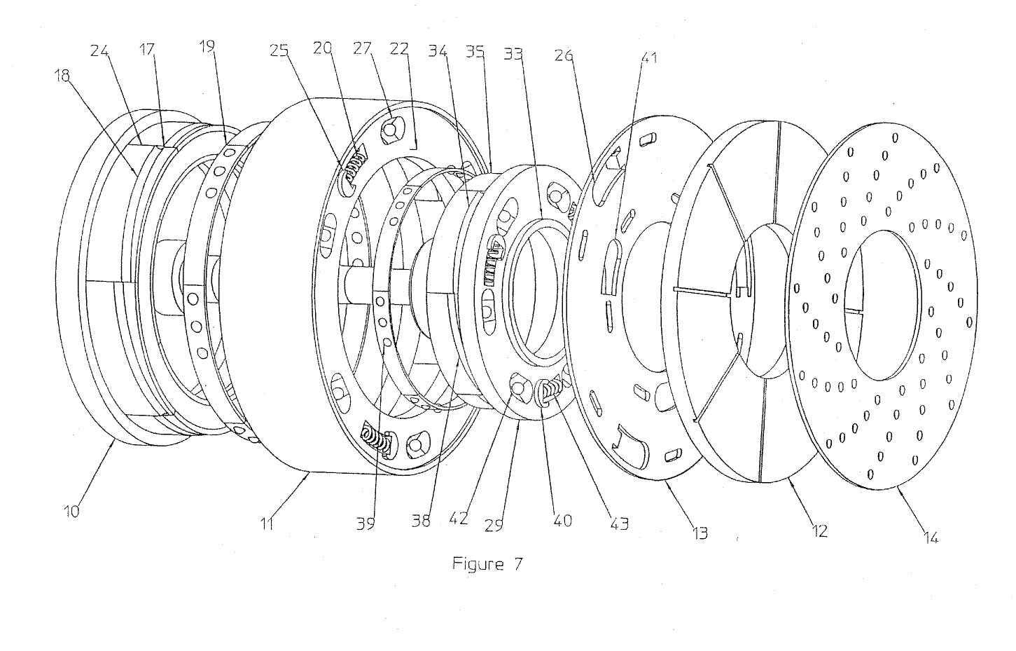

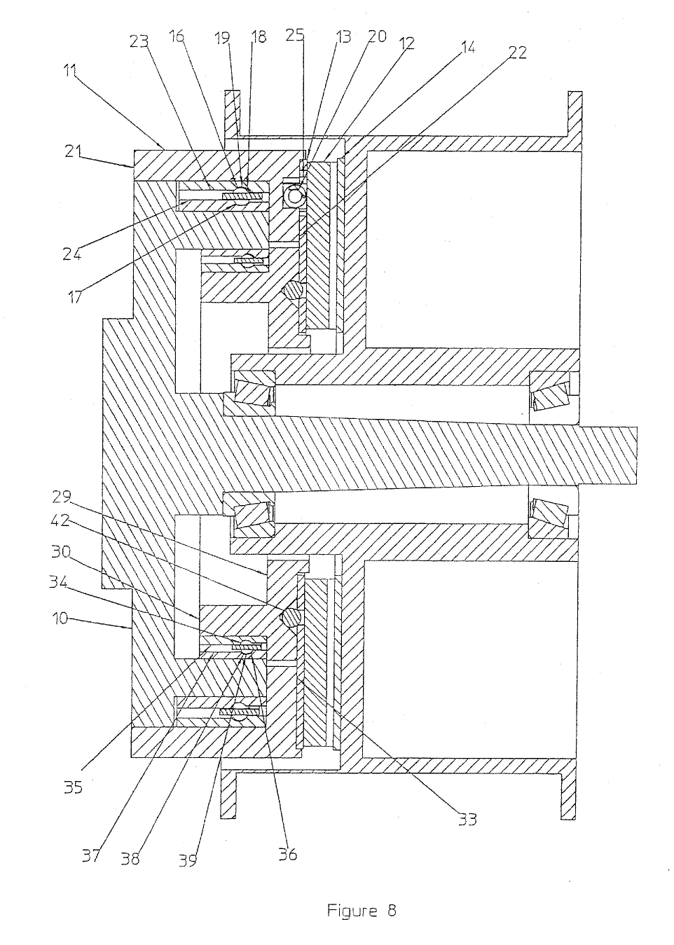

FIGS. 7 and 8 show yet another embodiment of a coaxial helical brake utilizing contra-rotating concentrically arranged pressure plates that engage a single brake pad carrier and brake pad. The helical rotation of the outer pressure plate 11 rotates opposite the rotor rotation when the vehicle travels forward. The helical rotation of the inner pressure plate 29 rotates opposite the rotor rotation when the vehicle travels in reverse. This configuration is suited to a brake-by-wire actuation system that can selectively actuate the outer pressure plate 11 when the vehicle is traveling forwards or actuate the inner pressure plate 29 when the vehicle travels in reverse. A parking brake pressure plate, with or without a dedicated brake pad carrier, can be incorporated into this embodiment.

Referring to FIGS. 7 and 8, a support element 10 is fitted with brackets (not shown) to mount it to the vehicle (not shown). An outer pressure plate 11 has a boss 21 affixed to or integral with its rear surface. An annular brake pad 12 is affixed to the front surface of brake pad carrier 13. The brake pad may also comprise individual segments of friction material. The outer pressure plate 11 is fitted with a circular flange 22 that locates and centers the brake pad carrier 13. A rotor 14 is affixed to the rotatable hub or wheel of the vehicle to be braked (not shown).

A series of equidistantly spaced helical grooves 16 with semicircular profiles is formed into the outer pressure plate boss's inner surface 23, and a matching series of grooves 17 is formed into the outer surface 24 of the support element 10. When the outer pressure plate 11 is mounted on the support element 10 the aligned grooves 16 and 17 form circular races 18. A caged series of bearing balls 19 is inserted into each race 18.

A series of lugs 25 is located on the face of the outer pressure plate 11 and a corresponding series of lugs 26 is located on the back surface of the brake pad carrier 13. The lugs 25 and 26 are designed to engage when the outer pressure plate 11 is rotated toward the brake pad carrier 13 so that the brake pad carrier 13 rotates with the outer pressure plate 11. A small amount of rotational movement allows the outer pressure plate 11 to disengage and rotate away from the pad carrier 13 when the brake is released. To assist such disengagement, a thrust race 27 or similar friction-minimizing device is located on the face of the outer pressure plate 11, and a return spring 20 is affixed to both the outer pressure plate 11 and the support element 10.

An outer actuation mechanism 15 (shown in FIG. 9) is mounted on the support element 10 in such a fashion so as to provide the most useful rotational actuation to the outer pressure plate 11. A brake adjuster assembly may be of any appropriate conventional type. When the vehicle is traveling forward and the brake is applied, an actuation system (not shown) selects the outer actuator 15, which includes but is not limited to mechanical, hydraulic, pneumatic, spring, electric or magnetic systems, causing the outer pressure plate 11 to rotate on the support element 10 and move towards the brake pad carrier 13, pushing the brake pad 12 into contact with the rotor 14. The outer actuator 15 can include a multiplicity of actuators and the actuator(s) can be mounted on the support element 10, the vehicle, or some other fixed point. The outer actuator 15 can be mounted in such a manner so as to provide the most useful rotational actuation to the outer pressure plate 11. The most favorable location and direction of the outer actuator 15 would be acting tangentially at the largest radius practical from the axle/brake assembly centerline, as shown in FIG. 9. A return spring and wear adjustment mechanism may be incorporated into the means of actuation or mounted directly to the relevant components, the vehicle, or some other fixed point.

An inner pressure plate 29 has a boss 30 affixed to or integral with its rear surface. The brake pad 12 remains affixed to the front surface of the brake pad carrier 13. The inner pressure plate 29 is fitted with a circular flange 33 that locates and centers the brake pad carrier 13.

A series of equidistantly spaced helical grooves 34 with semicircular profiles is formed into the inner pressure plate boss's outer surface 35, and a matching series of grooves 36 is formed into the inner surface 37 of the support element 10. When the inner pressure plate 29 is mounted on the support element 10 the aligned grooves 34 and 36 form circular races 38. A caged series of bearing balls 39 is inserted into each race 38.

A series of lugs 40 is located on the face of the inner pressure plate 29 and a corresponding series of lugs 41 is located on the back surface of the brake pad carrier 13. The lugs 40 and 41 are designed to engage when the inner pressure plate 29 is rotated towards the brake pad carrier 13 so that the brake pad carrier 13 rotates with the inner pressure plate 29. A small amount of rotational movement allows the inner pressure plate 29 to disengage and rotate away from the pad carrier 13 when the brake is released. To assist such disengagement, a thrust race 42 or similar friction-minimizing device is located on the face of the inner pressure plate 29, and a return spring 43 is affixed to both the inner pressure plate 29 and the support element 10.

An inner brake actuation mechanism (not shown) is mounted on the support element in such a fashion so as to provide the most useful rotational actuation to the inner pressure plate. A brake adjuster assembly may be of any appropriate conventional type. When the vehicle is traveling in reverse and the brake is applied, the actuation system selects the inner brake actuator, which includes but is not limited to mechanical, hydraulic, pneumatic, spring, electric or magnetic systems, causing the inner pressure plate 29 to rotate on the support element 10 and move towards the brake pad carrier 13, pushing the brake pad 12 into contact with the rotor 14 in the opposite rotational direction as rotor 14. Because the helical rotation of the inner pressure plate 29 is in the opposite direction as the rotor rotation when the vehicle is traveling in reverse, the brake pad 12 does not cause the rotor 14 to seize or lock-up. A return spring and wear adjustment mechanism may be incorporated into the means of inner actuation or mounted directly to the relevant components, the vehicle, or some other fixed point.

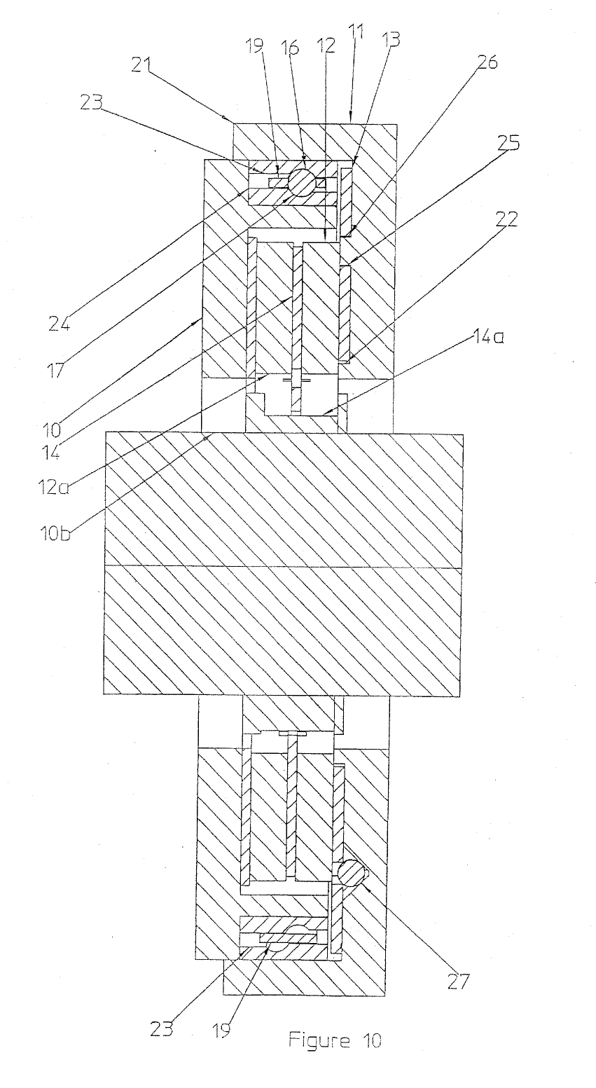

FIG. 10 is a cross-sectional view of yet another embodiment of a coaxial helical brake that eliminates axial or sideways loading on axle bearings. This configuration is especially suited for applications where conventional ball bearings rather than tapered bearings are used for axle bearings, as is the case with most karts. In order to eliminate axial loading from being transmitted to the axle bearings, all axial loading must be transmitted to the support element 10 which itself transmits such axial loading to the frame of the vehicle.

In this embodiment, the pressure plate 11 moves toward the support element 10 when the brake is applied as opposed to the previous embodiments where the pressure plate moved away from the support element. The brake pad carrier 13 and brake pad 12 are located outboard of the rotor 14 and the pressure plate 11 is constructed to extend over the brake pad carrier 13 and brake pad 12. The pressure plate 11 can then pull the brake pad carrier 13 and brake pad 12 toward the outer face of the rotor 14 as the pressure plate 11 moves toward the support element 10.

The rotor 14 may be of the floating type, located on the axle, shaft or hub by means of splines or pins. A second brake pad 12a is affixed to the support element 10 inboard of the floating rotor 14. When the brake is applied, the pressure plate forces the outer brake pad 12 into contact with the floating rotor 14 which in turn is forced into contact with the inner brake pad 12a creating the braking action.

This embodiment works equally well with multiple floating rotors and multiple floating intermediate brake pads similar to the above-described embodiment employing multiple rotors and stators.

Referring to FIG. 10, pressure plate 111 has a boss 21 affixed to or integral with its rear surface. An annular outer brake pad 12 is affixed to the front surface of the brake pad carrier 13. The pressure plate 11 is fitted with a circular flange 22, which locates and centers the brake pad carrier 13. A floating rotor 14 is located by means of splines 14a to the driven shaft 10b. A second brake pad 12a is fixedly mounted to the support element 10 inboard of the floating rotor 14.

A series of equidistantly spaced helical grooves 16 with semicircular profiles is formed into the pressure plate boss's inner surface 23, and a matching series of grooves 17 is formed into the outer surface 24 of the support element 10. When the pressure plate is mounted on the support element, the aligned grooves 16 and 17 form circular races 18. A caged series of bearing balls 19 is inserted into each race.

A series of lugs 25 is located on the face of the pressure plate 11 and a similar series of lugs 26 is located on the back surface of the brake pad carrier 13. The lugs 25 and 26 are designed to engage when the pressure plate 11 is rotated toward the brake pad carrier 13 so that the brake pad carrier 13 rotates with the pressure plate 11. A small amount of rotational movement allows the pressure plate 11 to disengage and rotate away from the brake pad carrier 13 when the brake is released. To assist such disengagement, a thrust race 27 or similar friction-minimizing device is located on the face of the pressure plate 11, and a return spring 20 is affixed to both the pressure plate 11 and the support element 10.

An actuation mechanism 15 (shown in FIG. 9) is mounted on the support element 10 in such a fashion so as to provide the most useful rotational actuation to the pressure plate 11. A brake adjuster assembly may be of any appropriate conventional type. When the brake is applied the actuator 15, which includes but is not limited to mechanical, hydraulic, pneumatic, spring, electric or magnetic systems, causes the pressure plate 11 to rotate on the support element 10 and move towards the brake pad carrier 13, pushing the brake pad 12 into contact with the rotor 14. The actuator 15 can include a multiplicity of actuators and the actuator(s) can be mounted on the support element 10, the vehicle, or some other fixed point. The actuator 15 can be mounted in such a manner so as to provide the most useful rotational actuation to the pressure plate 11. The most favorable location and direction of the actuator 15 would be acting tangentially at the largest radius practical from the axle/brake assembly centerline, as shown in FIG. 9. A return spring and wear adjustment mechanism may be incorporated into the means of actuation or mounted directly to the relevant components, the vehicle, or some other fixed point.

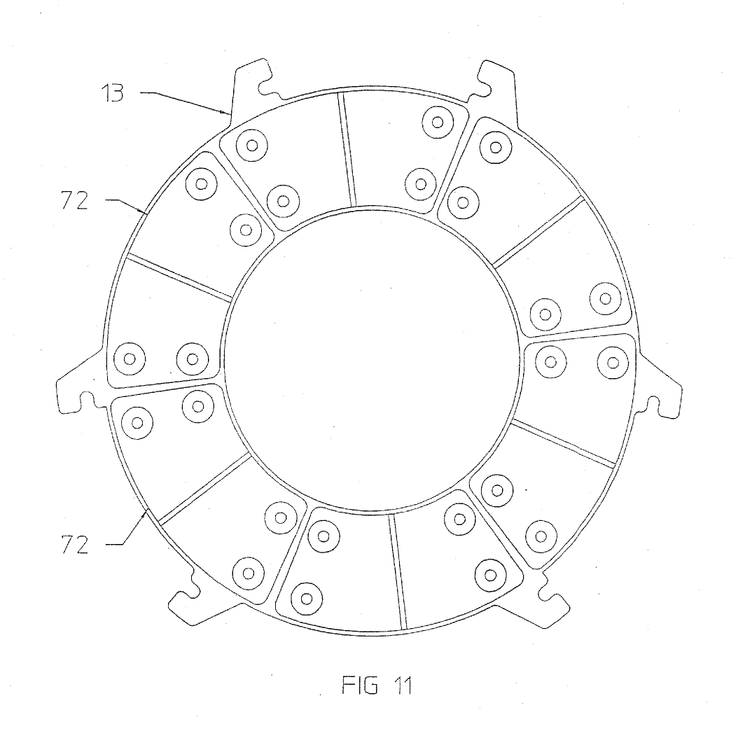

FIG. 11 shows a top plan view of a single brake pad carrier 13 with segmented brake pad material 72. The brake pad material 12 is segmented into pieces 72 for easier manufacturing of the brake pad material and easier installation and maintenance of the brake pad material.

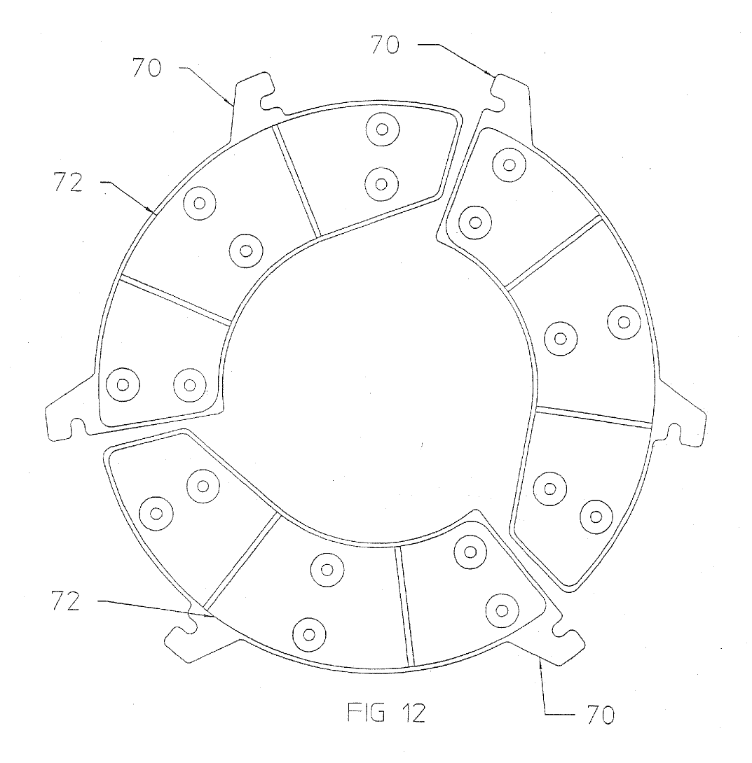

FIG. 12 shows a top plan view of a segmented brake pad carrier 70. Here, the brake pad carrier 13 is segmented into three brake pad carrier segments 70 for easier installation and removal from the support element 10.

FIG. 13 shows a perspective exploded view of a coaxial disc brake 100 according to another embodiment of the invention. In FIG. 13, brake pad carrier segments 70 are arranged in the support element 10 such that the segments 70 can be installed and removed from the disc brake 100 without the need to further disassemble the disc brake 100 or remove the rotating member (not shown) upon which the disc brake 100 acts.

FIG. 13 also shows the previously described low-friction material 27 interposed between the pressure plate 11 and the brake pad carrier segments 72. The low-friction material 27, shown here mounted on the engagement surface of the pressure plate 11, allows for easier disengagement of the pressure plate 11 from the brake pad carrier segments 72 upon completion of braking.

A further embodiment of the invention relates to its application to aircraft-type brakes that comprise a stack of alternating rotors and stators, the rotors being keyed to rotate with the wheel and the stators being keyed to a splined torque tube which is affixed to the vehicle and does not rotate with the wheel. The brake stack can comprise a single rotor and a single stator or a multiplicity of rotors and stators.

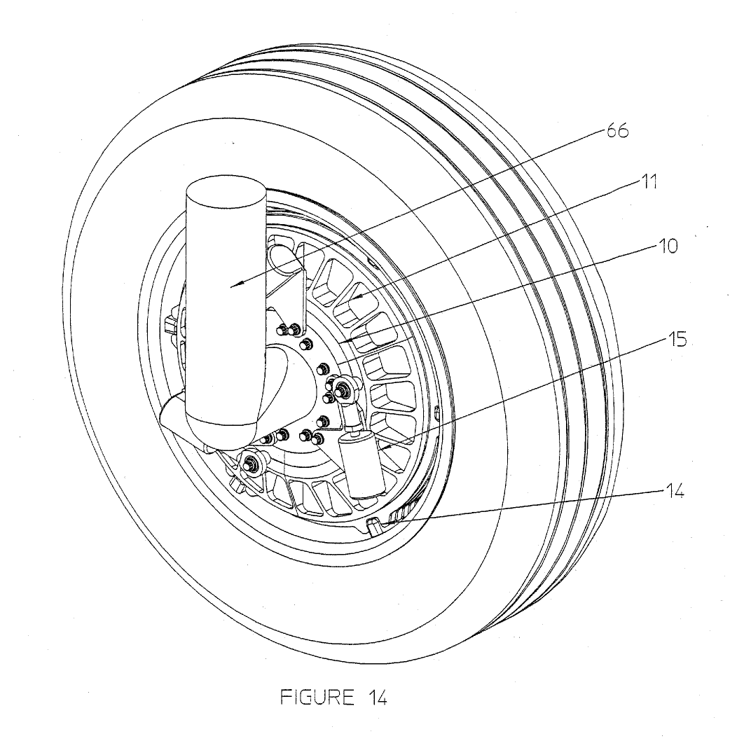

As described in a preceding embodiment relating to multiple rotor and stator brakes and illustrated in FIGS. 5 and 6, that embodiment employs a radially outer support element 10 which supports a radially inner pressure plate 111 in such a manner that the pressure plate 11 is rotatable in a helical motion relative to the support element 10. Light weight is an important design criterion for aircraft components. In order to reduce the weight of the brake, the radial dimension of the support element may be reduced by arranging the support element as the radially inner component and the pressure plate as the radially outer component. In this arrangement, the pressure plate is pressure plate is positioned radially outward of the support element so that the entire pressure plate, or a substantial portion of the pressure plate, is radially outward of the outer surface of the support element, as depicted in FIGS. 14-18. This structure reduces the size and weight of the support element which is advantageous to reducing the overall brake weight and size, e.g. for aircraft use.

Conversely, it may be advantageous in certain application to locate the pressure plate radially within the support element in a similar fashion to pressure plate 29 shown in FIGS. 3 and 4. There, the pressure plate is positioned radially inward of the support element and the entire pressure plate, or a substantial portion of the pressure plate, is inside the inner surface of the support element.

FIG. 14 is a perspective view of an aircraft-type multiple rotor and stator brake application according an embodiment of the invention. A fixed torque tube 50 10 is affixed to an aircraft strut 66 that is structurally connected to the aircraft body (not shown). The support element 10 and a first end each of three actuators 15 are affixed to the non-rotating torque tube 50. The second end of each actuator 15 is connected to the radially outwardly positioned pressure plate 11 such that the actuators 15 apply a tangential force and motion to the pressure plate 11 when actuated. The pressure plate 11 is helically engaged to an outer surface of the non-rotating support element 10. The brake rotors 14 are keyed to the rotating wheel. While three actuators 15 are shown in FIG. 14, it is contemplated that one, two or more than three actuators could be implemented depending on the force requirements.

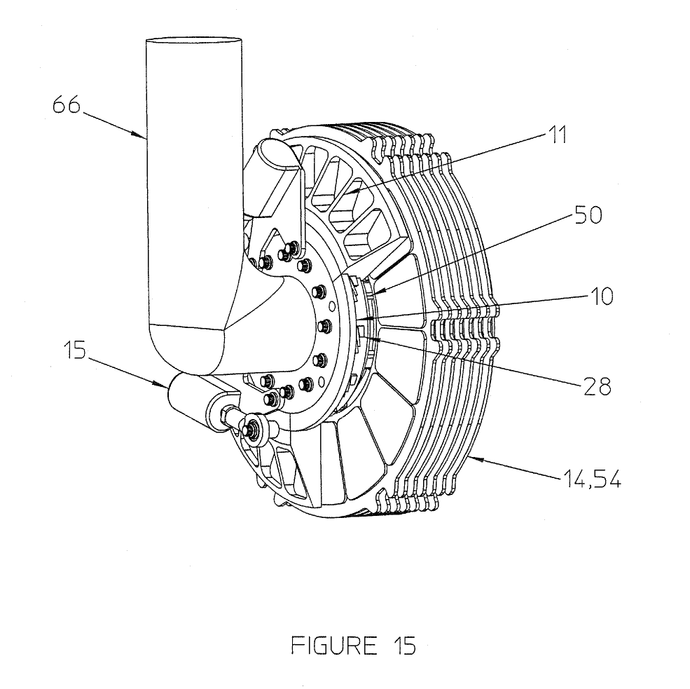

FIG. 15 is a detailed perspective cut-away view of the brake application of FIG. 14. The tire, a portion of the pressure plate and one of the three actuators are not shown so that the helical elements 28 on the outer surface of the support element and the stack of rotors 14 and stators 54 can be more clearly shown. The actuators 15 are arranged to apply a tangential force and thus motion to the pressure plate 11. The helical elements 28 on the outer surface of the support element 10 then cause the pressure plate 11 to move helically against the stack of rotors 14 and stators 54.

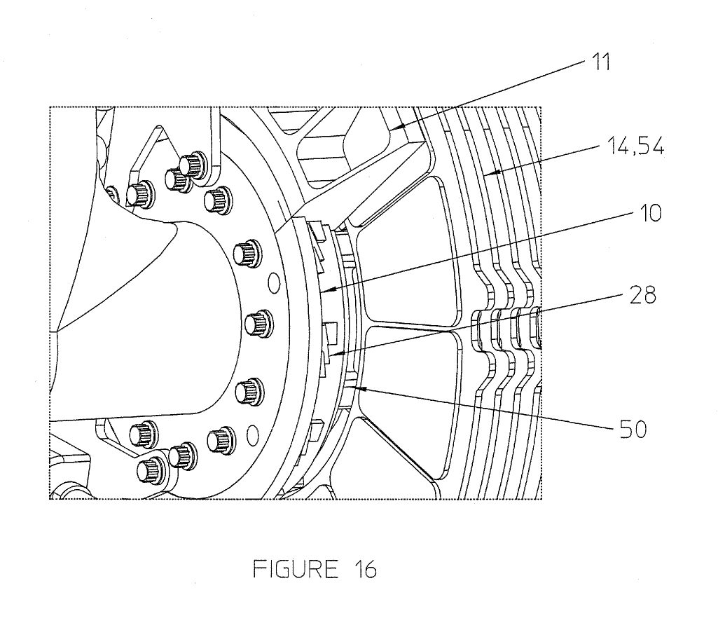

FIG. 16 is a detailed perspective view of the brake application of FIG. 14 showing the pressure plate 11. The pressure plate 11 is positioned to be completely radially outward of the support element 10. This allows for a smaller support element than in other embodiments which results in smaller and lighter brake components.

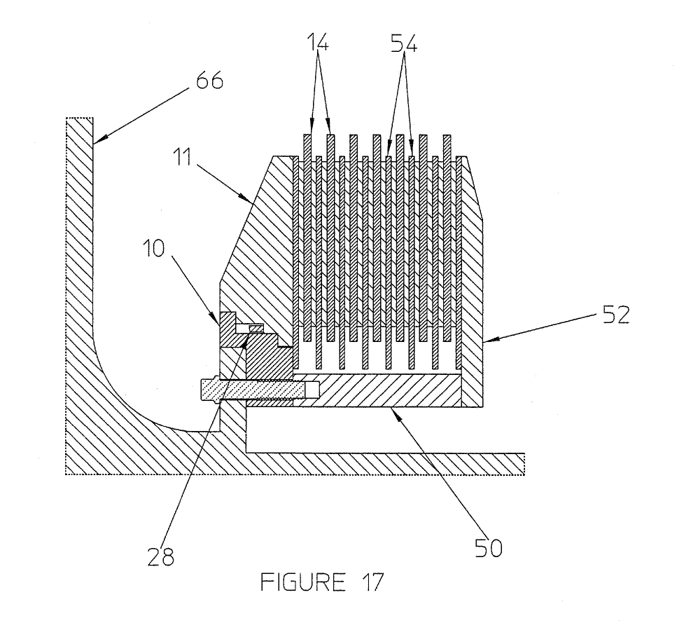

FIG. 17 is a half cross-sectional view of the brake application of FIG. 14 with the tire removed. The support element 10, the stators 14 and the back plate 52 are all affixed to the non-rotating torque tube 50 which is connected to the aircraft strut 66. The pressure plate 11 is helically engaged through the helical elements 28 with the support element 10 so that it also does not rotate except through the helical engagement during brake actuation. The rotors 14 are keyed to the rotating wheel.

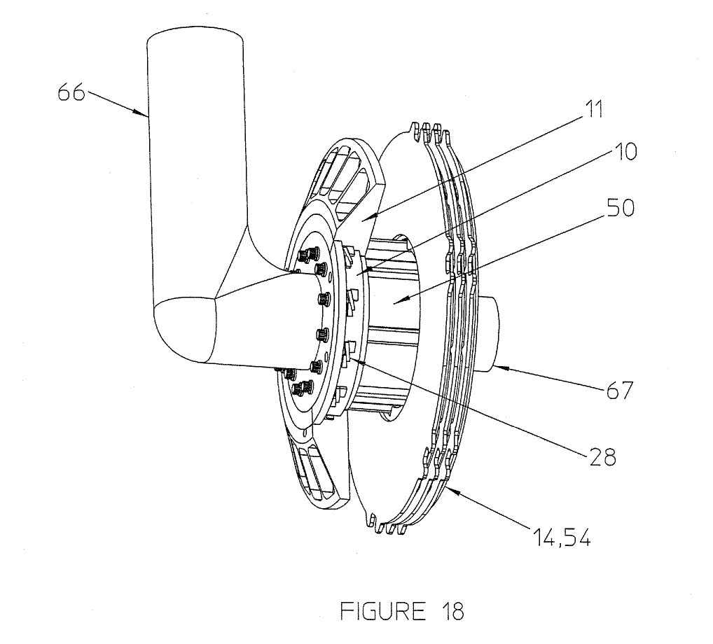

FIG. 18 is a perspective cut-away view of the brake application of FIG. 14 showing the pressure plate 11 and the stack of rotors 14 and stators 54 partially cut away. The spindle 67 is journalled on the torque tube 50 to allow rotation of the wheel and the rotors 14 keyed to the wheel. The torque tube 50 is affixed to the strut 66 with the support element 10 and the stators 54 affixed to the torque tube 50. The support element 10 supports the radially outwardly positioned pressure plate 11 with the helical elements 28 helically engaging the pressure plate 11.

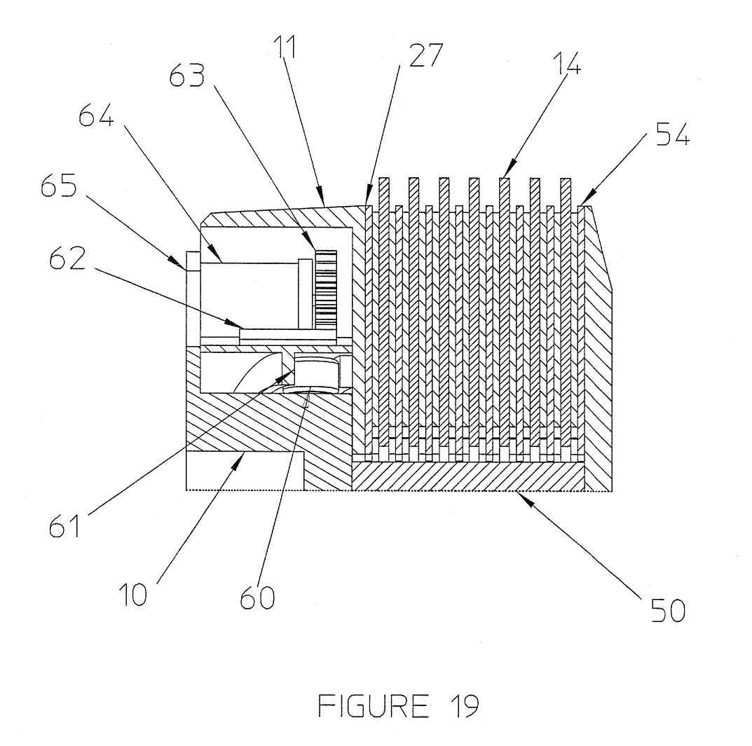

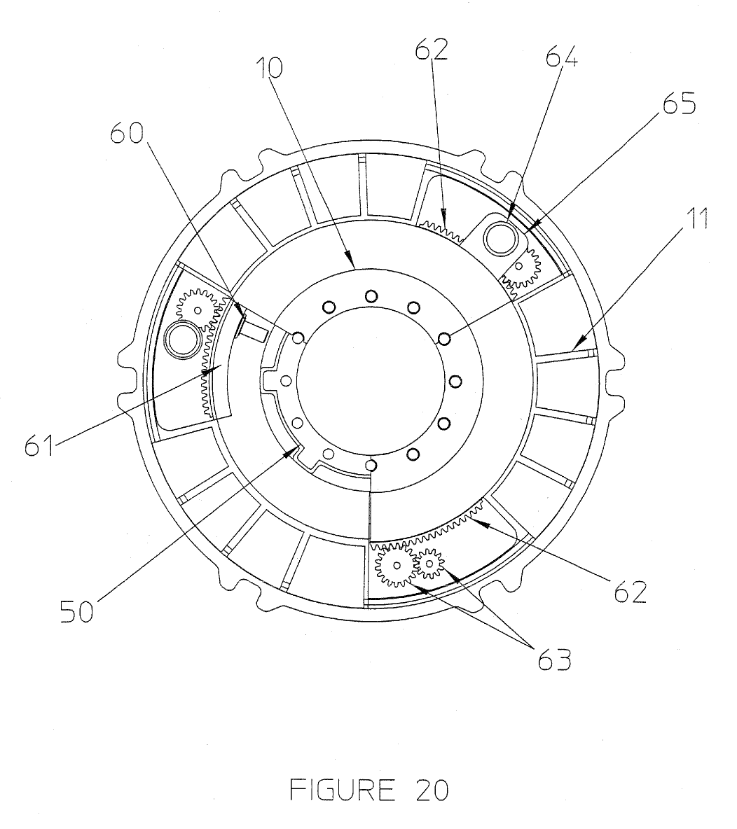

FIG. 19 is a side cross-sectional view of an aircraft-type multiple rotor and stator brake application according an embodiment of the invention shown in FIG. 14 and described below. FIG. 20 is a front cross-sectional view of the embodiment shown in FIG. 19. In the embodiment illustrated in FIGS. 19 and 20 support element 10 has three equidistantly spaced track rollers 60 affixed to its outer surface. Pressure plate 11 has three equidistantly spaced helical guide tracks 61 machined or cast into its inner surface, the helical guide tracks being dimensioned to accept track rollers 60. A single rotary actuator 64, which can be either an electric or a hydraulic motor, and gear train 63 assembly is shown, although additional actuators and gear trains can be employed for fail-safe functionality, redundancy or for applying higher forces. Actuator 64 is mounted on the actuator mounting bracket 65 which is affixed to or integral with support element 10. Support element 10 is affixed to torque tube 50. A stack of rotor 14 and stator 54 discs are located on torque tube 50.

At least one of the helical guide tracks 61 has its outer surface configured as a spur gear segment 62. Gear train 63 connects the actuator 64 with the spur gear segment 62. Spur gear segment 62 has sufficient axial width to permit pressure plate 11 to accommodate the maximum axial travel allowed by the helical guide tracks 61. When the shaft of the actuator 64 is rotated in a clockwise direction it causes, via the gear train 63, the pressure plate 11 to rotate in an anti-clockwise direction causing the track rollers 60 located within the helical track guides 61 to move the pressure plate 11 axially towards the stack of rotor 14 and stator 54 discs forcing them against each other to create friction and brake torque. The low friction interstitial element 27 disconnects the helical action from brake torque. Reversing the actuator shaft direction of rotation moves the pressure plate away from the disc stack.

Having described and illustrated the principles of the invention in the preferred embodiments thereof it should be apparent that the invention can be modified in arrangement and detail without departing from such principles. We claim all modifications and variations coming within the spirit and scope of the invention. The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications and variations would come within the scope of this invention.

1. A coaxial disc brake comprising:
a rotor with a braking surface, the rotor attachable to a rotating member;
a brake support structure mounted to a non-rotating structure associated with the rotating member;
a brake pad carrier supported by the brake support structure and arranged to have a braking surface facing the braking surface of the rotor;
brake pad material attached to the braking surface of brake pad carrier;
a pressure plate supported by the brake support structure and positioned on a side of the brake pad carrier opposite the rotor; and
an actuator mounted on the brake support structure, the actuator arranged to apply a rotational motion to the pressure plate,
where the rotor, brake support structure, brake pad carrier, and pressure plate are arranged coaxial to the rotating member,
and where the brake support structure is arranged to helically guide the pressure plate during actuation to axially engage the pressure plate against the brake pad carrier thereby axially engaging the brake pad material against the braking surface of the rotor.

2. The disc brake of claim 1, in which the brake pad carrier includes an inner brake pad carrier and an outer brake pad carrier concentrically arranged and independently movable;
the brake pad material attached to the brake pad carrier includes brake pad material attached to the inner and outer brake pad carriers;
the pressure plate includes an inner pressure plate and an outer pressure plate concentrically arranged and independently movable;
the actuator includes an inner actuator arranged to apply a rotational motion to the inner pressure plate in a first rotational direction and an outer actuator arranged to apply a rotational motion to the outer pressure plate in a second and opposite rotational direction;
the brake support structure is arranged to helically guide the inner pressure plate during actuation of the inner actuator to axially engage the inner pressure plate against the inner brake pad carrier thereby axially engaging the brake pad material against the braking surface of the rotor; and
the brake support structure is further arranged to helically guide the outer pressure plate during actuation of the outer actuator to axially engage the outer pressure plate against the outer brake pad carrier thereby axially engaging the brake pad material against the braking surface of the rotor.

3. The disc brake of claim 1, in which the rotor includes a plurality of rotors coaxially attached to the rotating member;
the brake pad carrier is a stator and includes a plurality of stators supported coaxially in the brake support structure and arranged to have each stator between two of the rotors; and
the brake support structure is arranged to helically guide the pressure plate during actuation to axially engage the stators with the rotors.

4. The disc brake of claim 1, in which the pressure plate includes an inner pressure plate and an outer pressure plate arranged concentrically and independently movable;
the actuator includes an inner actuator arranged to apply a first rotational motion to the inner pressure plate and an outer actuator arranged to apply an opposite second rotational motion to the outer pressure plate;
the brake support structure is arranged to helically guide the inner pressure plate during actuation of the inner actuator to axially engage the inner pressure plate against the brake pad carrier thereby axially engaging the brake pad material against the braking surface of the rotor; and
the brake support structure is further arranged to helically guide the outer pressure plate during actuation of the outer actuator to axially engage the outer pressure plate against the brake pad carrier thereby axially engaging the brake pad material against the braking surface of the rotor.

5. The disc brake of claim 1, in which the brake support structure is arranged to helically guide the pressure plate to axially engage the pressure plate against the brake pad carrier thereby axially engaging the rotor against a non-rotating structure associated with the rotating member.

6. The disc brake of claim 1, in which the brake pad material is attached to the braking surface of the rotor; and
the brake support structure is arranged to helically guide the pressure plate during actuation to axially engage the pressure plate against the brake pad carrier thereby axially engaging the brake pad carrier against the brake pad material on the braking surface of the rotor.

7. The disc brake of claim 1, in which the pressure plate includes an engagement surface facing an engagement surface on the brake pad carrier; and
the disc brake further comprises a low friction device interposed between the engagement surface of the pressure plate and the engagement surface of the brake pad carrier.

8. The disc brake of claim 1, in which the pressure plate includes an engagement surface facing an engagement surface on the brake pad carrier; and
at least one of the engagement surfaces includes a low friction coating.

9. The disc brake of claim 1, in which the brake pad material comprises segments of brake pad material arranged to substantially cover the braking surface of the brake pad carrier.

10. The disc brake of claim 9, in which the segments of brake pad material are sized and shaped to be installed and removed from the braking surface of the brake pad carrier without disassembling any of the brake support structure, rotor, and rotating member.

11. The disc brake of claim 1, in which the brake pad carrier includes at least two brake pad carrier segments.

12. The disc brake of claim 11, in which the at least two brake pad carrier segments are arranged to be installed and removed from the brake support structure without disassembling any of the brake support structure, rotor, and rotating member.

13. A method of braking a rotating member, comprising:
attaching a rotor with a braking surface coaxially with a rotating member;
mounting a braking support structure to a non-rotating structure associated with the rotating member, the braking support structure being mounted coaxially with the rotating member;
positioning a brake pad carrier in the braking support structure, the brake pad carrier having a braking surface facing the braking surface of the rotor and positioned to be coaxial with the rotating member;
applying a brake pad material to the braking surface of the brake pad carrier;
positioning a pressure plate in the braking support structure on a side of the brake pad carrier opposite the rotor, the pressure plate positioned to be coaxial with the rotating member;
applying a rotational motion to the pressure plate with an actuator; and
axially engaging the brake pad material with the braking surface of the rotor by helically guiding the pressure plate in the braking support structure causing the pressure plate to apply an axial force to the brake pad carrier.

14. The method of claim 13, in which positioning a brake pad carrier includes positioning an inner brake pad carrier in the braking support structure, the inner brake pad carrier having a braking surface facing the braking surface of the rotor, and further includes positioning an outer brake pad carrier in the braking support structure, the outer brake pad carrier having a braking surface facing the braking surface of the rotor, the inner and outer brake pad carriers being independently movable and arranged concentrically;
positioning a pressure plate includes positioning an inner pressure plate in the braking support structure on a side of the inner brake pad carrier opposite the rotor and positioning an outer pressure plate in the braking support structure on a side of the outer brake pad carrier opposite the rotor, the inner and outer pressure plates being independently movable and arranged concentrically;
applying a rotational motion to the pressure plate includes applying a rotational motion to at least one of the inner and outer pressure plates; and
axially engaging the brake pad material with the braking surface of the rotor includes engaging brake pad material on one of the inner and outer brake pad carriers against the braking surface of the rotor by helically guiding the one of the inner and outer pressure plates being rotated in the braking support structure to cause the rotated pressure plate to apply an axial force to the corresponding one of the inner and outer brake pad carriers.

15. The method of 13, in which axially engaging the brake pad material with the braking surface of the rotor includes helically guiding the pressure plate to cause the pressure plate to axially engage the brake pad carrier thereby causing the brake pad carrier to axially engage with the rotor and a non-rotating structure associated with the rotating member.

16. The method of claim 13, in which positioning a pressure plate in the braking support structure includes positioning an inner pressure plate in the braking support structure on a side of the brake pad carrier opposite the rotor and positioning an outer pressure plate in the braking support structure on the side of the brake pad carrier opposite the rotor, the inner and outer pressure plates being independently movable and arranged concentrically;
applying a rotational motion to the pressure plate includes applying a rotational motion to one of the inner and outer pressure plates; and
engaging the brake pad material with the braking surface of the rotor includes helically guiding the one of the inner and outer pressure plates being rotated to cause the rotated pressure plate to apply an axial load to the brake pad carrier.

17. The method of claim 13, in which causing the pressure plate to apply an axial force to the brake pad carrier includes helically engaging an engagement surface of the pressure plate against an engagement surface of the brake pad carrier and reducing friction between the engagement surfaces.

18. The method of claim 13, in which positioning a brake pad carrier in the braking support structure includes positioning at least two brake pad carrier segments in the braking support structure 10 such that the brake pad carrier segments can be removed from the braking support structure without disassembling any of the braking support structure, the rotor and the rotating member.

19. A coaxial disc brake comprising:
a rotor;
a brake pad carrier with brake pad material applied on a surface facing the rotor;
a pressure plate, with the rotor, brake pad carrier and pressure plate arranged coaxially; and
a means for helically engaging the pressure plate against the brake pad carrier thereby causing the brake pad carrier to move axially and the brake pad material to axially engage the rotor.

20. The disc brake of claim 19, in which the brake pad carrier includes an inner brake pad carrier and an outer brake pad carrier arranged concentrically;
the pressure plate includes an inner pressure plate and an outer pressure plate arranged concentrically; and
the means for helically engaging the pressure plate against the brake pad carrier includes a means for helically engaging the outer pressure plate against the outer brake pad carrier in a first rotational direction thereby causing the outer brake pad carrier to move axially and a means for helically engaging the inner pressure plate against the inner brake pad carrier in a second and opposite rotational direction thereby causing the inner brake pad carrier to move axially.

21. The disc brake of claim 19, in which the pressure plate includes an inner pressure plate and an outer pressure plate arranged concentrically; and
the means for helically engaging the pressure plate against the brake pad carrier includes a means for helically engaging the outer pressure plate against the brake pad carrier in a first rotational direction thereby causing the brake pad carrier to move axially and a means for helically engaging the inner pressure plate against the brake pad carrier in a second and opposite rotational direction thereby causing the brake pad carrier to move axially.

22. The disc brake of claim 19, in which the means for helically engaging a pressure plate against the brake pad carrier thereby causing the brake pad carrier to move axially and the brake pad material to axially engage the rotor includes axially engaging the brake pad material and rotor with a non-rotating structure.

23. The disc brake of claim 19, in which the means for helically engaging the pressure plate against the brake pad carrier includes a means for providing a low friction engagement between the pressure plate and the brake pad carrier.

24. The disc brake of claim 19, in which the brake pad carrier includes at least two brake pad carrier segments arranged to be installed and removed from the disc brake without further disassembling the disc brake.

25. The disc brake of claim 19 including a rotary actuator coupled to apply a rotational motion to the pressure plate.
